(19) United States
(12) Patent Application Publication
(10) Pub. No.: US 2023/0193573 A1
(43) Pub. Date: Jun. 22, 2023

(54) ENGINE LOAD METHOD FOR MODULATING PLUNGE CUTTING VELOCITY FOR A COLD PLANER

(71) Applicant: Caterpillar Paving Products Inc., Brooklyn Park, MN (US)

(72) Inventor: Timothy J Sturos, Saint Michael, MN (US)

(73) Assignee: Caterpillar Paving Products Inc., Brooklyn Park, MN (US)

(21) Appl. No.: 17/559,657

(22) Filed: Dec. 22, 2021

(51) Int. Cl. E01C 23/088

(52) U.S. Cl. CPC E01C 23/088

(57) ABSTRACT

A milling machine can include a frame; an engine coupled to the frame; a cutting rotor coupled to the frame and driven by the engine, the cutting rotor configured to be lowered a selected distance into a surface; and a controller, the controller being configured to modulate a plunge velocity of the cutting rotor into the surface based on an engine load target or an engine speed.

### TECHNICAL FIELD

The present disclosure generally relates to a milling machine. More particularly, the present disclosure relates to a system and method for modulating the plunge cutting velocity of a milling machine.

### BACKGROUND

Milling machines can include machines such as cold planers and reclaimers. For example, cold planers are powered machines used to remove at least part of a surface of a paved area such as a road, bridge, or parking lot. Typically, cold planers include a frame, a power source, a milling assembly positioned below the frame, and a conveyor system. The milling assembly includes a cutting rotor having numerous cutting bits disposed thereon. As power from the power source is transferred to the milling assembly, this power is further transferred to the cutting rotor, thereby rotating the cutting rotor about its axis. As the rotor rotates, its cutting bits engage the hardened asphalt, concrete, or other materials of an existing surface of a paved area, thereby removing layers of these existing structures.

When starting to cut with a cold planer or reclaimer it can be very hard on the machine to plunge into the cut too quickly. Plunge cutting involves lowering the cutting rotor into the surface to be cut. The cutting load on the engine is a function of several factors including the rate at which the cutting rotor is lowered. If the plunge velocity or rate is too fast, the engine can stall or the cutting rotor clutch can disengage.

U.S. Ser. No. 10/386,866 discusses a system for control of the plunge velocity based on the depth of the cut.

### SUMMARY

In an example according to this disclosure, a milling machine can include a frame; an engine coupled to the frame; a cutting rotor coupled to the frame and driven by the engine, the cutting rotor configured to be lowered a selected distance into a surface; and a controller, the controller being configured to determine an engine load and to modulate a plunge velocity of the cutting rotor into the surface based on an engine load target or an engine speed.

In an example according to this disclosure, a system for controlling a plunge velocity of a cutting rotor for a milling machine can include a controller configured to determine an engine load of the milling machine; and wherein the controller is configured to modulate the plunge velocity of the cutting rotor based on an engine load target or an engine speed while lowering the cutting rotor at a highest velocity while preventing an engine stall.

In one example, a method for controlling a plunge velocity of a cutting rotor for a milling machine can include determining an engine load while the cutting rotor is plunge cutting; and modulating the plunge velocity of the cutting rotor based on an engine load target or an engine speed.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a side view of a milling machine, in accordance with one embodiment.

FIG. 2 shows a side view of a reclaimer, in accordance with one embodiment.

FIG. 3 shows a schematic view of a control system, in accordance with one embodiment.

FIG. 4 shows a flowchart of a method, in accordance with one embodiment.

### DETAILED DESCRIPTION

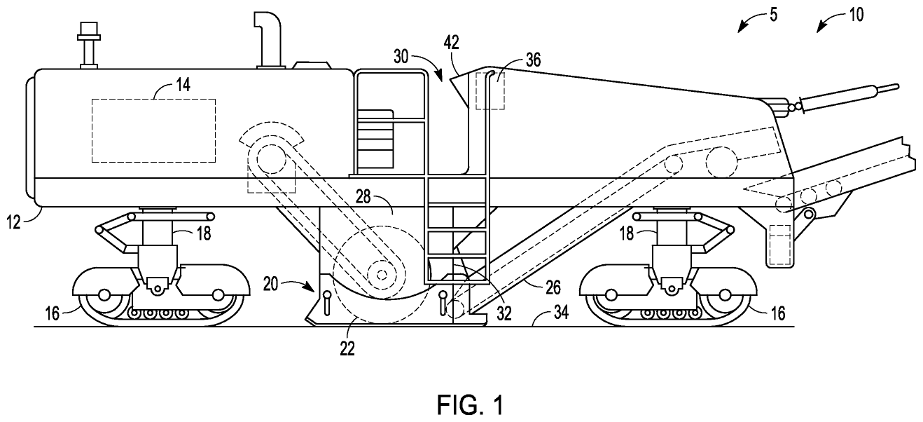

FIG. 1 shows a side view of a milling machine 5, in accordance with one embodiment. In this example, the milling machine 5 is a cold planer 10. The cold planer 10 includes a frame 12, and a power source, such as an engine 14, connected to the frame 12. The engine 14 may be provided in any number of different forms including, but not limited to, Otto and Diesel cycle internal combustion engines, electric motors, hybrid engines and the like.

The frame 12 is supported by transportation devices 16 via lifting columns 18. The transportation devices 16 may be any kind of ground-engaging device that allows to move the cold planer 10 in a forward direction over a ground surface 34, for example a paved road or a ground already processed by the cold planer 10. For example, in the shown embodiment, the transportation devices 16 are configured as track assemblies. The lifting columns 18 are configured to raise and lower the frame 12 relative to the transportation devices and the ground.

The cold planer 10 further includes a milling assembly 20 connected to the frame 12. The milling assembly 20 includes a drum housing 28 holding a rotatable cutting rotor 22 operatively connected to the engine 14. The cutting rotor 22 can be rotated about a drum axis extending in a direction perpendicular to the frame axis. As the rotatable cutting rotor 22 spins about its drum axis, cutting bits on the cutting rotor 22 can engage hardened materials, such as, for example, asphalt and concrete, of existing roadways, bridges, parking lots and the like. As the cutting bits engage such hardened materials, the cutting bits remove layers of these hardened materials. The spinning action of the cutting rotor 22 and its cutting bits then transfers the hardened materials to a first stage conveyor 26 via a discharge port 32 on the drum housing 28. The first stage conveyor 26 can be coupled to the frame 12 and located at or near the discharge port 32. To lower the cutting rotor 22 into the surface, the lifting columns 18 are adjusted accordingly to allow the for the desired depth of cut. Thus, the cutting rotor 22 is plunged by lowering the lifting columns 18 such that the whole frame 12 is lowered towards the ground surface 34.

The cold planer 10 further includes an operator station 30 including a control panel 42 for inputting commands to a control system for controlling the cold planer 10, and for outputting information related to an operation of the cold planer 10. A controller 36 can be provided for electrically controlling various aspects of the milling machine 5. For example, the controller 36 can send and receive signals from various components of the milling machine during the operation of the milling machine 5.

The speed at which the milling machine 5 should plunge into the cut (i.e., lower the cutting rotor 22 to the desired depth of cut in the surface 34) can be difficult to manage and control. The cutting load or engine load of the milling machine 5 is a function of several factors including the rate at which the cutting rotor 22 is lowered into the surface 34. If the plunge velocity or rate is too fast the engine 14 can stall or the cutting rotor clutch can disengage. Currently, the plunge velocity can be manually limited through an operator adjustable plunge velocity setting. However, if the situation changes the operator needs to remember to change the setting or it may be left at a less productive setting.

Accordingly, how fast the milling machine 5 should plunge into the cut depends on the engine load. The harder the material of the surface 34 being mixed or cut, then the more engine load is required and the slower the machine should plunge into the cut. Thus, there is need to determine engine load during the plunge cutting process of the surface 34 to determine a proper plunge velocity.

In this example, the controller 36 can be configured to modulate (i.e., control and vary) the plunge velocity of the cutting rotor 22 into the surface 34 based on a calculated engine load factor relative to an engine load target. For example, the controller 36 can determine at a given engine speed what percentage of the engine load or engine torque is being used. For example, the controller 36 can determine during cutting that at the given engine speed the engine 14 is using X % of the possible engine load. The engine 14 will stall if the engine 14 exceeds its torque (load) capacity. Thus, a target engine load (e.g., 80% of torque capacity) is determined and the controller 36 determines that to lower the cutting load, the plunge cutting velocity must be reduced. Accordingly, as the cutting rotor 22 is lowered, once the engine 14 hits a full load for its capacity (the target engine load), the plunge rate is slowed down to keep the engine 14 at full load. In this example, the controller 36 modulates the plunge velocity to prevent an engine stall.

Thus, the present system uses the engine load factor and/or engine speed to modulate the plunge velocity. To prevent engine stall, the plunge velocity can be actively managed to keep the engine speed lugged back only to the desired amount, typically full load. Over time, through an empirical study of a particular cutting rotor and machine combination, it can be possible to set a certain load factor limit which prevents engine stall or rotor cutout in a broader range of conditions than the current fixed plunge velocity limit method currently used.

In some examples, the plunge velocity can be continually modulated by the controller 36 depending on the calculated engine load or the engine speed relative to the engine load target. For example, the plunge velocity can begin at a nominal velocity, such as 16 mm/sec, and then can go up or down as desired to meet engine load requirement to prevent the engine 14 from stalling. Instead of using a fixed velocity, the system uses a load factor as the limiting factor and varies the plunge velocity accordingly.

If a relatively high engine load is calculated then the plunge velocity is lowered and if a relatively low engine load is calculated, the plunge velocity is raised. In one example, the engine speed can be monitored as a factor of the calculated engine load. For example, as the cutting rotor 22 begins to plunge the engine speed will go down as the engine load goes up. If the speed gets too low (or engine load gets too high) the controller 36 determines the need to lower plunge velocity to prevent an engine stall. In some examples, the plunge velocity is modulated such that an engine speed is only lowered enough for the calculated engine load to remains at full load.

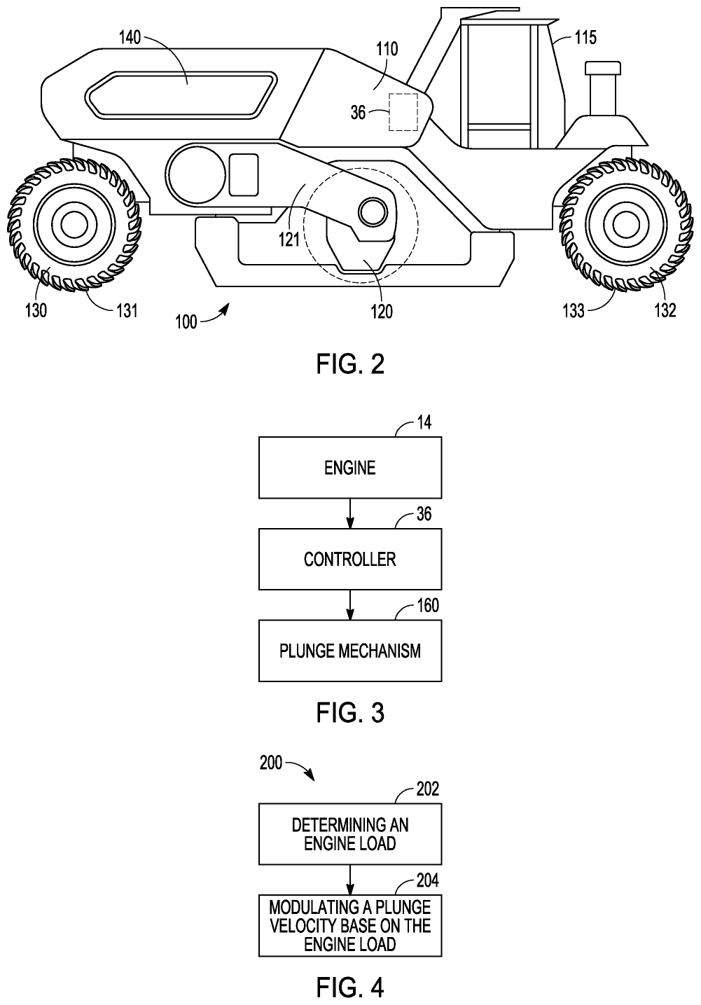

FIG. 2 shows a side view of another milling machine, such as a reclaimer 100, in accordance with one embodiment. The reclaimer 100 can also be known as a rotary mixer or a soil stabilizer. The reclaimer 100 generally includes a frame 110, a cutting rotor 120 attached to the frame 110 and contained within drum housing 122, and four wheels 130, 131, 132, 133 attached to the frame 110 for moving the reclaimer 100. The reclaimer 100 can also include a power source such as a diesel engine 140, which drives the various components, and an operator station 150 which can include various controls to control the operations of the reclaimer 100.

The cutting rotor is plunged into the surface using a lifting mechanism 160, which moves the cutting rotor 120 up and down relative to the frame 110. The cutting rotor 120 is rotated at a predetermined depth to dig up a soil surface or asphalt surface and then to lay the soil or pulverized asphalt back down to prepare a roadbed or other ground preparation. In some examples, further stabilizing material can be added to the soil or pulverized asphalt to be mixed into the roadbed.

As with the cold planer of FIG. 1, the reclaimer 100 can include a controller 36. The controller 36 can be configured to modulate (i.e., control and vary) the plunge velocity of the cutting rotor 120 into the surface based on a calculated engine load factor. The other details discussed above in regard to FIG. 1 are incorporated herein by reference.

FIG. 3 shows a schematic view of a control system, in accordance with one embodiment. The system is for controlling a plunge velocity of a cutting rotor for a milling machine and can include the controller 36, which can receive information from the engine 14 regarding engine speed and torque and the controller 36 can determine the percentage of torque being used for the received engine speed. Accordingly, the controller 36 can be configured to determine the engine load or cutting load of the milling machine during operation.

Further, the controller 36 can communicate with a plunge mechanism 160 of the milling machine. For example, the plunge mechanism represent the lifting columns 18 of the cold planer 10 or the cutting rotor lifting mechanism 160 of the reclaimer 100. The controller 36 can be configured to modulate the plunge velocity of the cutting rotor based on the engine load or the engine speed while lowering the cutting rotor at the highest velocity while preventing an engine stall. In other words, the plunge velocity is modulated such that an engine speed is only lowered enough for the calculated engine load to remain at full engine load.

In various examples of the system, the plunge velocity is continually modulated depending on the engine load or engine speed. The plunge velocity can begin at a nominal rate and the controller 36 raises or lowers the plunge velocity based on the engine load information received from the engine 14. As discussed, if a relatively high engine load is determined then the plunge velocity is lowered and if a relatively low engine load is determined, the plunge velocity is raised.

### INDUSTRIAL APPLICABILITY

The present system is applicable to a milling machine such as a cold planer or a reclaimer. As noted, the speed at which the milling machine 5 should plunge into the cut can be difficult to determine and can lead to engine stall if improperly managed.

FIG. 4 shows a flowchart of a method (200) for controlling a plunge velocity of a cutting rotor for a milling machine. The method (200) can include determining an engine load (202) while the cutting rotor is plunge cutting; and modulating the plunge velocity (204) of the cutting rotor based on a target engine load or an engine speed.

In various examples of the method, the plunge velocity can be modulated such that an engine speed is only lowered enough for the engine load to remains at full load. The cutting rotor can be lowered at the highest velocity while still preventing an engine stall. The plunge velocity can be continually modulated depending on the engine load. The engine load can be derived from a torque capacity of the engine. For example, the engine load can be a percentage of torque for a given engine speed. The target engine load can be the full engine load.

Thus, the present system uses the engine load factor and/or engine speed to modulate the plunge velocity. To prevent engine stall, the plunge velocity can be actively managed to keep the engine speed lugged back only to the desired amount, typically full load. Over time, through an empirical study of a particular cutting rotor and machine combination, it can be possible to set a certain load factor limit which prevents engine stall, rotor cutout and leg lift in a broader range of conditions than the current fixed plunge velocity limit method currently used.

The above detailed description is intended to be illustrative, and not restrictive. The scope of the disclosure should, therefore, be determined with references to the appended claims, along with the full scope of equivalents to which such claims are entitled.

What is claimed is:

1. A milling machine comprising:
a frame;
an engine coupled to the frame;
a cutting rotor coupled to the frame and driven by the engine, the cutting rotor configured to be lowered a selected distance into a surface; and
a controller, the controller being configured to determine an engine load and to modulate a plunge velocity of the cutting rotor into the surface based on an engine load target or an engine speed.

2. The milling machine of claim 1, wherein the controller modulates the plunge velocity to prevent an engine stall.

3. The milling machine of claim 1, wherein the plunge velocity is continually modulated depending on the engine load target or the engine speed.

4. The milling machine of claim 3, wherein the plunge velocity begins at a nominal rate and the controller raises or lowers the plunge velocity based on the engine load.

5. The milling machine of claim 1, wherein if a relatively high engine load is calculated then the plunge velocity is lowered and if a relatively low engine load is calculated, the plunge velocity is raised.

6. The milling machine of claim 1, wherein the plunge velocity is modulated such that an engine speed is only lowered enough for the calculated engine load to remain at full load.

7. The milling machine of claim 6, wherein the engine speed is monitored as a factor of the engine load target.

8. The milling machine of claim 1, wherein the milling machine comprises a cold planer and the cutting rotor is plunged by lowering a plurality of lifting columns of the cold planer such that the frame is lowered towards a ground surface.

9. The milling machine of claim 1, wherein the milling machine comprises a reclaimer and the cutting rotor is plunged by lowering the cutting rotor relative to the frame.

10. A system for controlling a plunge velocity of a cutting rotor for a milling machine, the system comprising:
a controller configured to determine an engine load of the milling machine; and
wherein the controller is configured to modulate the plunge velocity of the cutting rotor based on an engine load target or an engine speed while lowering the cutting rotor at a highest velocity while preventing an engine stall.

11. The system of claim 10, wherein the plunge velocity is continually modulated depending on the engine load or the engine speed.

12. The system of claim 11, wherein the plunge velocity begins at a nominal rate and the controller raises or lowers the plunge velocity based on the engine load.

13. The system of claim 10, wherein if a relatively high engine load is determined then the plunge velocity is lowered and if a relatively low engine load is determined, the plunge velocity is raised.

14. The system of claim 10, wherein an engine speed is monitored by the controller as a factor of the engine load.

15. The system of claim 14, wherein the plunge velocity is modulated such that the engine speed is only lowered enough for the engine load to remains at full load.

16. A method for controlling a plunge velocity of a cutting rotor for a milling machine, the method comprising:
determining an engine load while the cutting rotor is plunge cutting; and
modulating the plunge velocity of the cutting rotor based on a target engine load or an engine speed.

17. The method of claim 16, wherein the plunge velocity is modulated such that an engine speed is only lowered enough for the engine load to remain at full load.

18. The method of claim 17, wherein the cutting rotor is lowered at a highest velocity while preventing an engine stall.

19. The method of claim 16, wherein the plunge velocity is continually modulated depending on the engine load.

20. The method of claim 16, wherein the target engine load is derived from a torque capacity of the engine.
